(19) United States
(12) Patent Application Publication
(10) Pub. No.: US 2008/0152472 A1
(43) Pub. Date: Jun. 26, 2008

(54) Gripper

(76) Inventors: Hans-Peter Wild, Eppelheim (DE); Eberhard Kraft, Neckarbischofsheim (DE); Frank Lechert, Weinheim (DE)

Correspondence Address: STROOCK & STROOCK & LAVAN LLP, 180 MAIDEN LANE, NEW YORK, NY, 10038, US

(21) Appl. No.: 11/869,484

(22) Filed: Oct. 9, 2007

(30) Foreign Application Priority Data
Oct. 13, 2006 (EP) 06021509.2

(51) Int. Cl. B65G 47/90

(52) U.S. Cl. 414/739

(57) ABSTRACT

An apparatus for transporting objects may include a plurality of grippers having a first spacing at a first position and second spacing at a second position. A drive mechanism may be provided is for selectively displacing the grippers from the first position to the second position to adjust the spacing between the grippers.

### BACKGROUND OF THE INVENTION

This invention relates, in general, to an apparatus for gripping an article, for example, while transporting the article. More specifically, the apparatus can be suitable for gripping a flat portion of the article, for example, the seam of a foil bag. The apparatus can be used to suspend the article, for example, while conveying the article horizontally.

Gripping apparatuses can include two clamping jaws movable relative to each other, wherein the jaws are movable via a transmission element, from a gripping position to an opened position and vice versa. The gripping apparatuses available in the market, however, are often not suitable or are limited when suspending and transporting thin articles, such as foil bags. For example, the clamping force of the jaws applied on the articles may be compromised by irregularities in the transmission elements. Whereas the compromised force may be insignificant when the article is relatively thick, thin articles such as foil bags may be sensitive to such compromises in the clamping force.

In light of the shortcomings described above, it is desirable to provide an apparatus and system for gripping and transporting products.

### SUMMARY

Generally speaking, the present invention is directed toward an apparatus for gripping an article for transport, preferably a relatively thin article, such as a foil bag having a relatively thin seam. The gripping apparatus can contact both sides of the seam and apply sufficient pressure, or clamping force, to grasp and suspend the article as it is being transported to another station, conveyor belt, etc. The gripping apparatus preferably includes a toggle lever for controlling the clamping motion of the gripping apparatus.

Objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE FIGURES

For a fuller understanding of the invention, reference is had to the following description, taken in connection with the accompanying drawings, in which:

FIG. 1 is a perspective view of an apparatus in accordance with an embodiment of the invention in a first position;

FIG. 2 is a cross-sectional view of the apparatus of FIG. 1;

FIG. 3 is a cross-sectional view of the apparatus of FIG. 1 in a second position.

### DETAILED DESCRIPTION

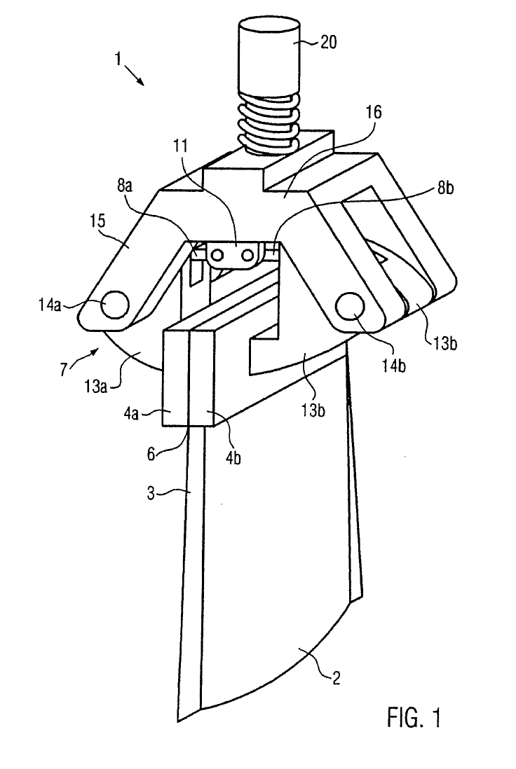

Reference is made to FIGS. 1-3, wherein an embodiment of a gripping apparatus 1 is illustrated. FIG. 1 shows gripping apparatus 1 gripping an article 2, such as a foil bag. Article 2 can include a sealing edge 3, which can be thin, preferably having a thickness of less than about 0.5 mm, more preferably between about 0.02 and 0.5 mm.

An exemplary embodiment of gripping apparatus 1 can be connected to and, preferably extends downward from, a continuously rotating conveying system, such as a conveyor chain. Alternatively, gripping apparatus 1 can be mounted on individually movable arms, or moved back and forth, or otherwise arranged to convey article 2 from one position to another.

Referring to FIGS. 1-3, gripping apparatus 1 can include a clamping assembly having a first jaw 4a and a second jaw 4b pivotally displaceable with respect to each other. The clamping assembly can also include a first arm 13a connected to first jaw 4a, and a second arm 13b connected to second clamping jaw 4b. Preferably, jaws 4a, 4b are shaped to accommodate article 2 being gripped therebetween. For example, in the embodiment shown, jaws 4a, 4b are substantially rectangular having a flat inner surface to grip the flat sealing edge 3 of article 2.

Gripping apparatus 1 preferably includes an actuating assembly 9 constructed and arranged to displace jaws 4a, 4b toward and away from each other. An exemplary embodiment of actuating assembly 9 illustrated in FIGS. 1-3 includes a base 15, a rod 18, an intermediate member 11, and a toggle lever comprising a first lever 8a and a second lever 8b. Preferably, first lever 8a is connected to intermediate member 11 at a first end and first arm 13a at a second end. Likewise, second lever 8b is connected to intermediate member 11 at a first end and second arm 13b at a second end. The embodiment of levers 8a, 8b as shown have a generally elongated cylindrical shape. Therefore, reference is made to first and second ends of levers 8a, 8b. However, it is to be understood that levers 8a, 8b can include a variety of shapes and are not limited to elongated members or cylindrical members.

Referring to the embodiment of the toggle lever illustrated, first lever 8a is pivotally attached to intermediate member 11 via a first pivot 10a, and second lever 8b is pivotally attached to intermediate member 11 via a first pivot 10b. Additionally, first lever 8a can be pivotally attached to first arm 13a via a third pivot 12a, and second lever 8b can be pivotally attached to second arm 13b via a fourth pivot 12b. Preferably, first pivot 10a and second pivot 10b are spaced apart from third pivot 12a and fourth pivot 12b, respectively.

First arm 13a is preferably fixedly connected to first jaw 4a, and second arm 13b is preferably fixedly connected to second jaw 4b. The toggle lever in accordance with the invention preferably provides an increased force generated by jaws 4a, 4b with reduced movement and less force than systems known in the art. Therefore, the gripper apparatus in accordance with an embodiment of the invention can be used at higher speeds and lower pressure than previously known systems.

Gripper apparatus can further include a base 15 having an aperture 17 through which rod 18 extends in a direction represented as double arrow P. Preferably, the wear and tear of rod 18 and aperture 17 is insignificant. Preferably, rod 18 is displaceable along aperture 17 toward and away from jaws 4a, 4b. Such linear motion preferably reduces certain drawbacks of previously known systems. Base 15 can also be connected to the clamping assembly, preferably to first and second arms 13a, 13b. In the embodiment shown, first and second arms 13a, 13b are pivotally connected to base 15 via fifth pivot 14a and sixth pivot 14b, respectively. In accordance with the embodiment shown, fifth pivot 14a and sixth pivot 14b are spaced away from third pivot 12a and fourth pivot 12b, respectively. Preferably, portions of base 15 extend toward arms 13a, 13b as shown in FIGS. 1-3.

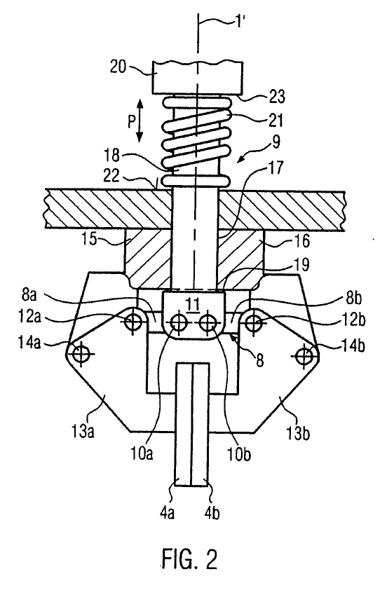

Referring to FIG. 2, rod 18 can be connected to an operating head 20, which can include, by way of non-limiting example, a cam follower of a cam control for levers 8a, 8b.

Alternatively, operating head 20 can be selectively depressed or otherwise displaced toward jaws 4a, 4b, to displace rod 18 toward jaws 4a, 4b. Preferably, rod 18 is fixed to operating head 30 so that the movement of operating head 20 is transferred into the movement of rod 18.

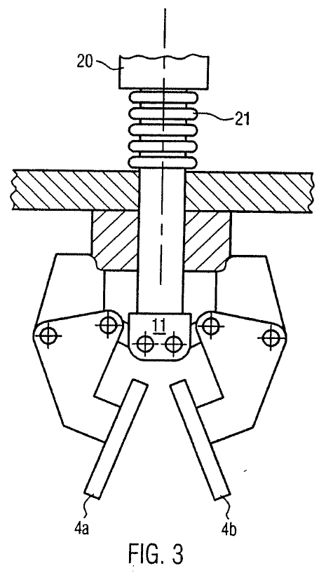

A spring 21 is preferably provided to urge operating head 20 away from base 15, thus urging rod 18 away from jaws 4a, 4b. Referring to FIG. 3, spring 21 preferably has a minimum height wherein spring 21 is substantially completely contracted between base 15 and operating head 20. More specifically, when spring 21 abuts stopper surface 23 of operating head 20 and can no longer contract, for example, based on the thickness of spring 21, rod 18 is preferably fully extended.

When rod 18 is fully extended in accordance with the embodiment shown in FIG. 3, intermediate member 11 is moved toward jaws 4a, 4b. Because levers 8a, 8b of the embodiment shown are pivotally attached at one end to intermediate member 11 and arms 13a, 13b at the opposite end, as intermediate member 11 is moved away from base 15 toward jaws 4a, 4b, levers 8a, 8b are pivoted about first and second pivots 10a, 10b toward base 15 and away from jaws 4a, 4b to create an angle of less than 180° with respect to one another. Additionally, because arms 4a, 4b are pivotally connected to base 15 at fifth and sixth pivots 14a, 14b, the pivoting motion of levers 8a, 8b causes arms 13a, 13b to pivot about fifth and sixth pivots 14a, 14b away from each other. According, jaws 14a, 14b, which are fixed to arms 13a, 13b, are also separated and move apart from one another, thus creating a gap in which article 2 can be received.

Reference is made to FIG. 2, wherein an embodiment of rod 18 is fully retracted, which is preferably the rest position of gripping apparatus 1 when no force is exerted thereon. In the embodiment shown, first pivot 10a, second pivot 10b, third pivot 12a and fourth pivot 12b are aligned in a common plane. As shown, intermediate member 11 is moved toward base 15 until prevented from moving further. For example, intermediate member 11 preferably has a width that is greater than the diameter of aperture 17, and therefore a face 19 of intermediate member 11 can abut a guide portion 16 of base 15, whereupon rod 18 is prevented from retracting any further. As shown, levers 8a, 8b can pivot about first and second pivots 10a, 10b away from base 15 and toward jaws 4a, 4b until levers 8a, 8b are aligned, more specifically, having an angle of 180° with respect to one another. Levers 8a, 8b pivot about third and fourth pivots 12a, 12b with respect to arms 13a, 13b. Preferably, simultaneously, arms 13a, 13b pivot about fifth and sixth pivots 14a, 14b toward each other until jaws 4a, 4b contact each other. Accordingly, if a portion of article 2 is present between jaws 14a, 14b, jaws 4a, 4b can grasp the portion of article 2 therebetween. Preferably, the opposing force between jaws 4a, 4b is sufficient to maintain a relatively thin article 2, such as a foil bag, more specifically, the sealing edge 3 in place. The force is preferably strong enough to suspend and convey article 2 while grasping sealing edge 3.

In accordance with an exemplary embodiment, a lining 6 is provided on the surface of jaws 4a, 4b to facilitate grasping and retaining article 2 between jaws 4a, 4b. Lining 6 is preferably a friction-increasing lining. Examples of lining 6 include a nap lining having relatively low flexibility.

Preferably, gripping apparatus 1 is substantially symmetrical about a center plane 1′ extending through operating head 20, rod 18, intermediate member 11 and between jaws 4a, 4b. For example, levers 8a, 8b are symmetrical to each other about center plane 1′.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, two or more elements can be combined into single elements, and single elements can be divided into multiple parts without deviating from the scope of the invention. Additionally, other alterations can be made as a matter of application specific to design choice, without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-10. (canceled)

11. A gripping apparatus comprising:
a clamping assembly comprising a first jaw and a second jaw, wherein the first jaw is displaceable relative to the second jaw, the clamping assembly further comprising a first arm and a second arm, the first arm being connected to the first jaw and the second arm being connected to the second jaw; and
an actuating assembly constructed and arranged to displace the first jaw relative to the second jaw; the actuating assembly comprising a displaceable rod assembly, a first lever member and a second lever member, and a first arm and a second arm;
the first and second lever members each having a first end pivotally connected to the displaceable rod assembly;
the displaceable rod assembly having an extended position wherein the clamping assembly is in an open position, wherein first and second jaws are positioned apart from each other; and
the displaceable rod assembly having a retracted position wherein the clamping assembly is in a closed position, wherein first and second jaws are positioned toward each other.

12. The apparatus of claim 11, wherein the rod assembly includes a movable intermediate piece pivotally connected to the first end of the first lever member at a first pivot point, the intermediate piece pivotally connected to the first end of the second lever member at a second pivot point, the first pivot point being spaced apart from the second pivot point.

13. The apparatus of claim 11, wherein the first lever member includes a second end pivotally connected to the first arm at a third axis point; and the second lever member includes a second end pivotally connected to the second arm at a fourth axis point.

14. The apparatus of claim 13, wherein the actuating assembly further includes a first base and a second base, wherein the first arm is pivotally connected to the first base at a fifth axis point and the second arm is pivotally connected to the second base at a sixth axis point, wherein the third axis point is spaced apart from the fifth axis point, and the fourth axis point is spaced apart from the sixth axis point.

15. The apparatus of claim 11, wherein the first and second pivot axis points includes at least one pivot bearing pin and at least one pivot bearing bore constructed and arranged to receive the pivot bearing pin.

16. The apparatus of claim 11, wherein the actuating assembly further comprises a spring constructed and arranged to urge the rod assembly toward the retracted position.

17. The apparatus of claim 11, wherein the actuating assembly further comprises a stopper assembly constructed and arranged to prevent the rod assembly from extending past the extended position.

18. The apparatus of claim 17, wherein the stopper is connected to the rod assembly.

19. The apparatus of claim 11, wherein the actuating assembly including a slide bearing constructed and arranged to receive the rod assembly therein, wherein the rod assembly is displaceable within the slide bearing.

20. The apparatus of claim 11, further comprising a carrier, wherein the rod assembly is movably connected to the carrier, and the clamping assembly is pivotally connected to the carrier.

21. A gripping apparatus comprising:
a clamping assembly comprising a first jaw and a second jaw, wherein the first jaw is displaceable relative to the second jaw, the clamping assembly further comprising a first arm and a second arm, the first arm being connected to the first jaw and the second arm being connected to the second jaw;
an actuating assembly constructed and arranged to displace the first jaw relative to the second jaw, the actuating assembly comprising a displaceable rod assembly, a first lever member and a second lever member, and a first arm and a second arm;
the first lever member having a first end pivotally connected to the displaceable rod assembly at a first axis point;
the second lever member having a first end pivotally connected to the displaceable rod assembly at a second axis point;
the first lever member including a second end pivotally connected to the first arm at a third axis point;
the second lever member including a second end pivotally connected to the second arm at a fourth axis point;
the displaceable rod assembly having an extended position wherein the clamping assembly is in an open position, wherein first and second jaws are positioned apart from each other; and
the displaceable rod assembly having a retracted position wherein the clamping assembly is in a closed position, wherein first and second jaws are positioned toward each other; and
a base assembly comprising a receiving member having a channel, the receiving member constructed and arranged to displaceably receive the rod assembly within the channel; the base assembly further comprising a first base member and a second base member, wherein the first arm is pivotally connected to the first base member at a fifth pivot point, and the second arm is pivotally connected to the second base member at a sixth pivot point;
wherein the apparatus is constructed and arranged such that when the rod assembly is extended, the first and second lever members pivot about first and second pivot points toward the base assembly, the first and second arms pivot about the first and second lever members about third and fourth pivot points and further pivot about fifth and sixth pivot points such that first and second jaws are displaced away from each other; and
when the rod assembly is retracted, the first and second lever members pivot about first and second pivot points away from the base assembly, the first and second arms pivot about the first and second lever members about third and fourth pivot points and further pivot about fifth and sixth pivot points such that first and second jaws are displaced toward each other.

22. A gripping apparatus comprising:
a clamping assembly comprising a first jaw and a second jaw, wherein the first jaw is displaceable relative to the second jaw; and
an actuating assembly constructed and arranged to displace the first jaw relative to the second jaw; the actuating assembly comprising a toggle lever assembly having a first lever and a second lever each being pivotally connected to a displacement member, the first lever and the second lever being operatively associated with first jaw and second jaw, respectively,
wherein the pivotal displacement of the first lever with respect to the displacement member displaces the first jaw; and
wherein the pivotal displacement of the second lever with respect to the displacement member displaces the second jaw.
